(19) United States
(12) Patent Application Publication
(10) Pub. No.: US 2009/0004912 A1
(43) Pub. Date: Jan. 1, 2009

(54) Sub-Assembly Frame Comprising a Standard Rear Panel and Sub-Assemblies that Have at Least a Double Width

(75) Inventor: Martin Rau, Cascais (PT)

Correspondence Address: BELL, BOYD & LLOYD, LLP, P.O. BOX 1135, CHICAGO, IL, 60690, US

(73) Assignee: SIEMENS AKTIENGESELLSCHAFT, München (DE)

(21) Appl. No.: 11/661,243

(22) PCT Filed: Aug. 18, 2005
(86) PCT No.: PCT/EP2005/054080

§ 371 Date: Feb. 26, 2007

(30) Foreign Application Priority Data
Sep. 2, 2004 (EP) 04020916.5

(51) Int. Cl. H01R 13/66

(52) U.S. Cl. 439/540.1

(57) ABSTRACT

In one aspect, a device for use in sub-assembly frames with a standard rear panel and cross-links that connect directly adjacent slots of the sub-assembly frame in pairs is provided. The device connects the cross-links in such a way that a communication path is also available for sub-assemblies that are wider than one slot.

The invention relates to a device which makes it possible to insert sub-assemblies having at least a double width in a sub-assembly frame with a standard (e.g. VME, cPCI, ACTA) rear panel, with directly adjacent sub-assemblies that have at least a double width being connected by available cross-links.

Modern telecommunications networks impose on the network infrastructure constantly increasing demands which are ever more difficult for conventional cabling and known constructional principles to fulfill. Scalable capacities of up to 2.5 Tb/s with an availability of up to 99.999% and a simultaneously high level of modularity and configurability are demanded for example. The systems must be able to accommodate large pools of digital signal processors, network and other processors as well as high-capacity memory and at the same time be able to be installed and maintained at low cost.

Conventional constructions and architectures have inadequate redundancy concepts and feature sub-assemblies which are too small for future applications. The leakage power dissipation of conventional architectures is insufficient and the rear panels intended to link the powerful sub-assemblies have lack the capacity to do so.

Efforts are thus being made to provide new and more versatile mechanical design solutions which take account of the particular needs of telecommunications systems. The result of these efforts has been the creation of standards such as the Advanced Telecom Computing Architecture (ATCA). The ACTA standard makes provision for a mechanical design for larger sub-assemblies with hot-plug capabilities and supports the full redundancy of all units. In this standard leakage power of up to 200 watts per sub-assembly slot can be dissipated.

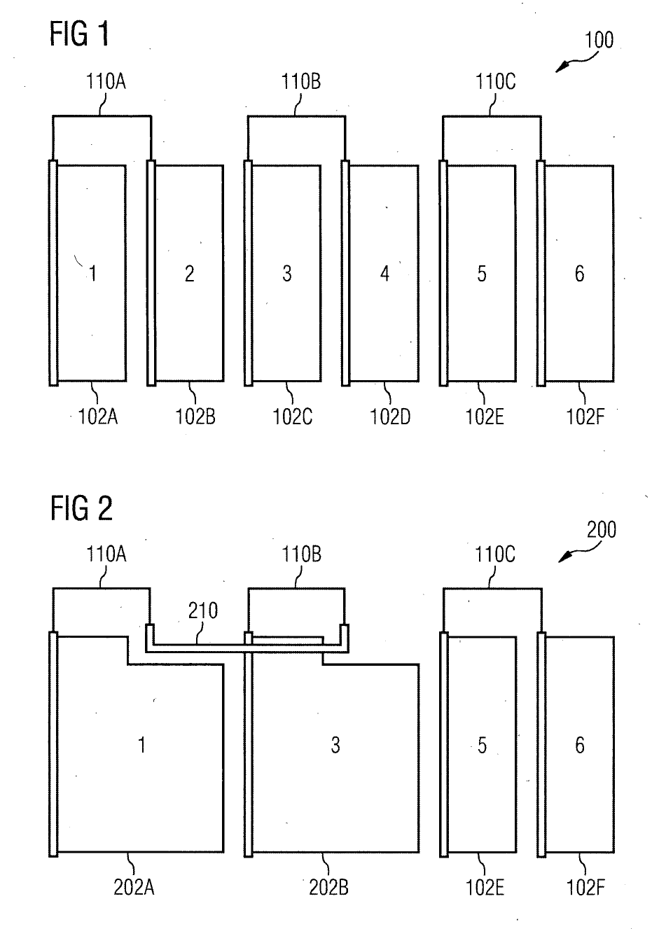

All sub-assembly mounting locations, also called “slots”, have a predetermined, uniform width, so that equipping of a sub-assembly frame with functionally different modules or sub-assemblies in any given combination is possible. For highly reliable platforms, which includes the majority of telecommunications systems, the standards in such cases provide for rear panels supporting sub-assemblies that are redundant (e.g. present more than once) by providing direct cross-links (x-link) implemented in the rear wiring panel of the sub-assembly frame between the redundant modules. The ATCA standard for example defines what is known as the “Update Channel”, for this purpose which usually connects adjacent slots. This is shown schematically in FIG. 1.

FIG. 1 shows a schematic diagram of a section of a system 100 with a standard rear panel. The section shown comprises 6 slots 102A-F for single-height sub-assemblies (the height extends in FIG. 1 to the right from the sub-assembly inserted in the sub-assembly carrier), with adjacent slots being connected in pairs by x-links 110A-C of the rear panel. In detail a first slot 102A and a second slot 102B (or the modules which can be inserted in these slots respectively) are connected by a first x-link 110A, a third slot 102C is connected to a fourth slot 102D by a second x-link 110B and a fifth slot 102E is connected to a sixth slot 102F by a third X-link 110C.

The problem is however that such a standard rear panel prevents the viable use of redundant double-width sub-assemblies, i.e. sub-assemblies requiring two slots, since taller components, e.g. heat sinks require this facility, or because the power dissipation exceeds the maximum power able to be dissipated per single slot. If such sub-assemblies are inserted into standard frames as shown in FIG. 1, the x-links 110A-C can no longer be used and there can be no direct communication between the redundant sub-assemblies. This makes system redundancy impossible.

The object of the present invention is to specify a device which makes it possible to use sub-assemblies having at least a double width in sub-assembly frames with a standard rear panel, in which adjacent assemblies of the at least double-width sub-assemblies are to be connected by means of cross-links and with the standard rear panel featuring only cross-links which connect directly adjacent slots.

This object is achieved by a device for use in sub-assembly frames with a standard rear panel, with the standard rear panel featuring cross-links which connect the immediately adjacent slots of the sub-assembly frames in pairs. The outstanding features of the device are as follows:
First contact elements which can be connected at least to the cross-link contacts of a first slot pair;
Second contact elements which can be connected at least to the cross-link contacts of a second slot pair; as well as
Connecting elements, which are connected to the first and second contact elements in order to create a cross-link between a first slot of the first slot pair and a first slot of the second slot pair;
with the first and second contact elements and the connecting elements being designed to permit sub-assemblies with at least a double width to be assembled on the respective second slots of the slot pairs.

The device advantageously connects the available cross-links so that this communication path is also available for sub-assemblies that are wider than one slot.

Advantageous embodiments of the inventive device are the object of the dependent claims.

A particular advantage of the invention is to be seen in the fact that it enables standard rear panels to also be used for wider redundant slots. This allows expensive project-specific rear panel development to be dispensed with for these applications. Contact and connection elements can be universally employed once they have been created. Each sub-assembly slot can be converted into a slot of any width. In such cases systems already installed can also be upgraded with the inventive devices in a simple manner and without interrupting operation to support the connection of sub-assemblies of greater width via cross-links.

The invention is explained below in greater detail in exemplary embodiments with reference to figures. Preferred exemplary embodiments are first explained in which double-width sub-assemblies are inserted in a standard rear panel. Exemplary embodiments with more than double-width sub-assemblies are subsequently described.

FIG. 1 shows a schematic diagram of a section of a system with a standard rear panel, prepared for insertion of single-width sub-assemblies.

FIG. 2 shows a schematic diagram of a section of a system with a standard rear panel, prepared for insertion of double-width sub-assemblies.

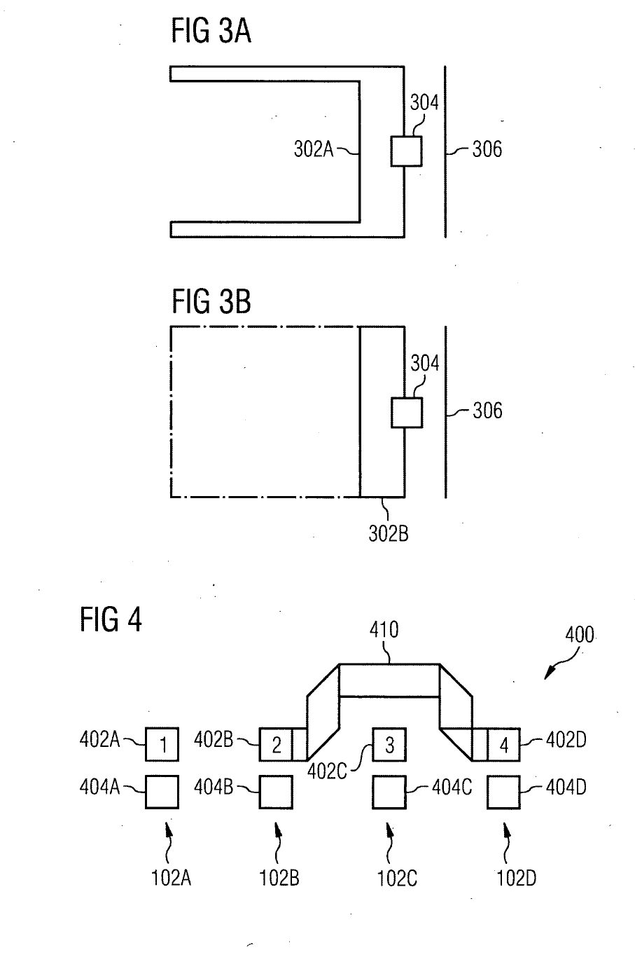

FIGS. 3A-B show schematic diagrams of two embodiments of the contact elements of the inventive device.

FIG. 4 shows a schematic diagram of a ribbon cable as a connecting element for use in the inventive device.

As already explained, FIG. 1 shows a schematic diagram of a section of a system 100 with standard rear panel. The section shown comprises 6 slots 102A-F for single-height sub-assemblies (the sub-assembly height extends in this diagram to the right from the carrier of the sub-assembly used), with adjacent pairs of slots being connected in each case by x-links 110A-C of the rear panel.

FIG. 2 shows a section of a system 200, also featuring the standard rear panel from FIG. 1. In this case double-width slots 202A and 202B have been created, with slot 202A being a combination of slots 102A and 102B and slot 202B corresponding to a combination of slots 102C and 102D. Redundant double-width sub-assemblies, e.g. sub-assemblies with taller components or with a power dissipation which exceeds the maximum power leakage that can be dissipated per single slot, can be inserted in these double-width slots for example.

In this case a connection 210 made in accordance with the invention, which connects the cross-link rear panel connectors (not shown) of the slots 102B and 102D, makes it possible for the available cross-links 110A-B of the standard rear panel to be used to create a cross-link between the double-width slots 202A and 202B. This cross-link is implemented by means of the available cross-link 110A, the inventive connection 210 between the original slots 102B and 102D from FIG. 1 and the available cross-link 110B.

FIGS. 3 and 4 show a schematic diagram of the individual elements of the inventive device.

Unequipped sub-assembly carriers can be provided as contact elements which are created so as to allow the use of double-width sub-assemblies and which are inserted in each case in the slots covered by the double-width sub-assemblies (102B, 102D from FIG. 1).

FIG. 3A shows a first example of such an unequipped sub-assembly carrier 302A. Sub-assembly carrier 302A has a connector 304 for connection to the plug-in rear panel contact which carries the lines of the cross-link. Optionally further connectors of the sub-assembly carrier 302A can be connected to further rear panel plug-in contacts. The position of the rear panel is indicated by a line 306. The sub-assembly carrier 302A is essentially U-shaped, with the cutout corresponding to the area in which the taller contacts according to the specification may be arranged. The remaining upper and lower arms are used to guide the unequipped sub-assembly carrier 302A in the slot. Furthermore the sub-assembly carrier has means for connecting the connecting elements, for example solder points or plug-in connector elements or transceivers for wireless connections, or is permanently connected to the connection elements.

FIG. 3B shows a second example of an unequipped sub-assembly carrier 302B. Sub-assembly carrier 302B has a connector 304 for connection to the plug-in rear panel contact which carries the lines of the cross-link. Optionally further connectors of the sub-assembly carrier 302B can be connected to further rear panel plug-in contacts. The position of the rear panel is once more indicated by a line 306. The sub-assembly carrier 302B is essentially rectangular and essentially only covers the connector area of a standard sub-assembly carrier. The dimensions of a standard sub-assembly carrier are shown for comparison purposes by a dashed line. This guarantees that any area in which components may be arranged according to the specification is not covered up. Sub-assembly carrier 302B can also be dimensioned as regards its height to enable it to be inserted into the guide rails of a sub-assembly carrier. The sub-assembly carrier 302B likewise has means for connecting the connecting elements, for example solder points or plug-in connector elements or transceivers for wireless connections, or is permanently connected to the connection elements. Sub-assembly carriers according to FIG. 3B can additionally be secured by screws or latching devices.

Furthermore simple plug connectors can be provided as contact elements for plugging directly into the rear panel, if the plug-in force alone guarantees a reliable and durable connection in keeping with the corresponding constructional standards—not shown in the diagram. Such connectors can be secured additionally by screws or latching devices.

The connection means can be designed as a cable connection and can connect by means of the contact elements at least the cross-link rear panel plug-in connectors of the slots 102B and 102D covered.

In the ATCA standard what is known as a zone 3 is provided which is reserved for application-specific expansions and can be used for cable routing. In such cases an application-specific rear panel can be provided only for zone 3. It is further possible to use Rear Transitioning Modules® which are connected via cables, or a direct cable connection can be routed through zone 3.

The cable connection can also be routed through the front panel. With a u-shaped unequipped sub-assembly carrier 302A in particular connectors can be mounted on the front panel, into which the cable connection is then plugged, in order to connect the adjacent double-width slots.

FIG. 4 shows the use of ribbon cable 410 for connecting the cross-link rear panel plug-in contacts 402B and 402D. To put it more precisely, FIG. 4 shows the first 4 slots 102A-D from FIG. 1 Each of these slots typically features two rear panel plug-in contacts 402A-D and 404A-D. It is assumed here that the plug-in contacts 402 include the cross-link lines. The plug-in contacts 404 on the other hand do not carry any of the lines associated with cross-links. Ribbon cable 410 can be laid through a gap between the individual plug-in connectors 402, 404 since nowadays ribbon cables can be constructed from layers of flexible carrier material. This means that they meet all requirements for constant surge impedance and, because of full screening, also meet requirements for electromagnetic compatibility (induced radiation, emitted radiation). The ATCA standard for example demands a gap between sub-assembly carrier and rear panel, through which such a ribbon cable can be routed. Only gaps in the rear panel connector strip are necessary, as are always provided in what is known as star cabling except at the hub slot. The ribbon cable can be folded; to enhance mechanical stability additional stiffening materials may be necessary.

If a ribbon cable cannot be inserted or if the gap between sub-assembly carrier and rear panel is too small or not present, corresponding cutouts can be provided in the sub-assembly carrier which are then used for cable routing—not shown in the diagram. Thicker cables can then also be routed between rear panel and sub-assembly carrier. This means that the use of such a sub-assembly in accordance with standards is in no way restricted.

Finally it is possible to provide cable connections above or below the sub-assembly carrier to be inserted, or to access the rear panel plug-in contacts on the side facing away from the sub-assembly (solder side) of the rear panel.

Naturally it is possible also to use the inventive device explained in conjunction with double-width sub-assemblies in conjunction with sub-assemblies of greater width—not shown in the diagrams. With triple-width sub-assemblies for example the first triple-width sub-assembly inserted in slot 102A of FIG. 1 would cover up slots 102A-C, and the second triple-width sub-assembly inserted in slot 102D would cover up slots 102D-F. To create end-to-end cross-links, the cross-link rear panel connectors of slots 102B and 102C are then to be connected by means of an inventive device. In this case this can consist of a simple cable connection with suitable connectors; It does not have to be routed through sub-assembly carriers since slots 102B and 102C are in the area covered up by the sub-assembly used in slot 102A.

Consequently the connection of the cross-links for triple-width sub-assemblies is especially simple. It can therefore be advantageous to provide triple-width sub-assemblies instead of double-width sub-assemblies, since the connection 210 can be implemented in an especially simple and low-cost manner in this way.

The principle can also be applied to even wider sub-assemblies, with routing via the sub-assembly slot being required for all even-numbered width factors, but not for odd-numbered width factors.

1-8. (canceled)

9. A device for use in sub-assembly frames comprising a standard rear panel with the standard rear panel having cross-links that connect directly adjacent slots of the sub-assembly frame in pairs, comprising:
a first contact element connected to a cross-link contact of a first slot pair;
a second contact element connected to the cross-link contact of a second slot pair; and
a connecting element connected to the first and second contact elements in order to create a cross-link between a first slot of the first slot pair and a first slot of the second slot pair,
wherein the first and second contact elements and the connecting elements being designed to permit a sub-assembly with at least a double width to be assembled on the respective second slot of the slot pair.

10. The device as claimed in claim 9, further comprising a cross-link between pairs of slots directly adjacent to the first slot for use of double-width sub-assemblies in the respective second slots of the slot pairs.

11. The device as claimed in claim 10, wherein the first or second contact element comprises a rear panel plug-in connector that is plugged into a cross-link contact of the rear panel.

12. The device as claimed in claim 11, wherein the first or the second contact element comprises a short carrier module including dimensions so that the short carrier module does not impede components of a wide sub-assembly inserted into an adjacent slot.

13. The device as claimed in claim 11, wherein the first or second contact element comprises a carrier module including external dimensions corresponding to a standard dimensions applicable for the sub-assembly frame, the carrier module comprises a cutout dimensioned such that the short carrier module does not impede components of a wide sub-assembly accommodated in a directly adjacent slot.

14. The device as claimed in claim 13, wherein the connecting element comprises a ribbon cable laid on the plug-in side of the rear panel along gaps between contacts or contact groups of the rear panel.

15. The device as claimed in claim 13, wherein the connecting element comprises a cable which is connected to a front panel-side connection of the first and second contact elements.

16. The device as claimed in claim 13, wherein for use in a sub-assembly frame with a rear panel according to the ATCA standard, in which the connecting element comprises a cable which is routed in a zone 3 of the rear panel.

17. The device as claimed in claim 9, wherein the first or second contact element comprises a rear panel plug-in connector that is plugged into a cross-link contact of the rear panel.

18. The device as claimed in claim 9, wherein the first or the second contact element comprises a short carrier module including dimensions so that the short carrier module does not impede components of a wide sub-assembly inserted into an adjacent slot.

19. The device as claimed in claim 9, wherein the first or second contact element comprises a carrier module including external dimensions corresponding to a standard dimensions applicable for the sub-assembly frame, the carrier module comprises a cutout dimensioned such that the short carrier module does not impede components of a wide sub-assembly accommodated in a directly adjacent slot.

20. The device as claimed in claim 9, wherein the connecting element comprises a ribbon cable laid on the plug-in side of the rear panel along gaps between contacts or contact groups of the rear panel.

21. The device as claimed in claim 9, wherein the connecting element comprises a cable which is connected to a front panel-side connection of the first and second contact elements.

22. The device as claimed in claim 9, wherein for use in a sub-assembly frame with a rear panel according to the ATCA standard, in which the connecting element comprises a cable which is routed in a zone 3 of the rear panel.
